(19) United States
(12) Patent Application Publication
(10) Pub. No.: US 2025/0315649 A1
(43) Pub. Date: Oct. 9, 2025

(54) ROBUST ONLINE AND OFFLINE ADAPTATION OF PRE-TRAINED MODELS TO UNSEEN FIELD DATA

(71) Applicant: Schlumberger Technology Corporation, Sugar Land, TX (US)

(72) Inventors: Indranil Roychoudhury, Menlo Park, CA (US); Prasham Sheth, Menlo Park, CA (US); Jose Celaya Galvan, Menlo Park, CA (US)

(21) Appl. No.: 19/170,560

(22) Filed: Apr. 4, 2025

Related U.S. Application Data
(60) Provisional application No. 63/574,689, filed on Apr. 4, 2024.

(51) Int. Cl. G06N 3/044; G05B 13/02; G06N 3/096

(52) U.S. Cl. CPC G06N 3/044; G05B 13/027; G06N 3/096

(57) ABSTRACT

Systems and methods for adapting models of physical systems using transfer learning or adaptation techniques (e.g., Jacobian Feature Regression) in both online and offline modes are presented herein. The systems and methods presented herein extend implementation of transfer learning or adaptation techniques to physics-informed neural networks modeled using a state-space formulation, demonstrate that transfer learning or adaptation techniques is more sustainable than other retraining and transfer learning methods, demonstrate how an offline adaptation approach may be modified into an online adaptation technique, and demonstrate the application of online and offline adaptation algorithms on applications relevant to the oil and gas industry, such as membranes, compressors, and so forth.

### CROSS-REFERENCE TO RELATED APPLICATIONS

This application claims priority to and benefit of U.S. Provisional Patent Application No. 63/574,689, filed on Apr. 4, 2024, which is incorporated by reference herein in its entirety.

### FIELD OF THE INVENTION

Aspects of the disclosure relate to systems and methods for adapting models of physical systems using transfer learning or adaptation techniques (e.g., Jacobian Feature Regression) in both online and offline modes.

### BACKGROUND INFORMATION

Modeling and simulation of engineering systems (often referred to as digital twins) benefit many applications, such as optimization, control, forecasting, prognostics and health management, automation, and decision-making, among others. Such models may be physics-based, such as a system of dynamic differential equations, or data-driven, such as a machine learning model (including deep learning models such as artificial neural networks), or a hybrid combination of both physics-based and data-driven models, such as a physics-informed neural network. Typically, building such models involve operating the system in a more constrained environment than the real world, like in a laboratory setting or a machine-shop setting to collect data, and then using this “training dataset” to calibrate the parameters of the model (e.g., equation parameters or weights of the neural networks).

Unfortunately, the “test data” and “validation data” for these systems usually come from the real world, where the system will operate when fielded and can sometimes be very different from the laboratory or machine shop setting. In addition, often, a model of a system needs to be built that is different from what was built using stale or obsolete “training data.” This shortcoming appears in applications in general, but is more apparent in prognostics/health management. In applications of prognostics and health management, there is also often a requirement to build models of faulty or degraded systems, and it is nearly impossible to replicate all possible failure conditions that the system will encounter when deployed. Therefore, there are always some gaps in coverage of nominal and faulty operating conditions.

Many possible ways are available that make this “generalization” of the model trained on laboratory data to a broader real-world environment, such as retraining of machine learning models, recalibration of the model parameters based on some initially collected field data, and so forth. However, many of these approaches are computationally expensive and cannot be used in dynamic, fast-changing environments that need quick recalibration requirements compared to a complete re-training of the ML model that is typically both data-and time-intensive.

### SUMMARY

A summary of certain embodiments described herein is set forth below. It should be understood that these aspects are presented merely to provide the reader with a brief summary of these certain embodiments and that these aspects are not intended to limit the scope of this disclosure.

In one non-limiting embodiment, a method includes initially training, via an analysis and control system, a model of a physical system. The model of the physical system includes a data-driven model or a hybrid model that includes a combination of a physics-based definition of the physical system and data collected relating to the physical system. The method also includes utilizing, via the analysis and control system, transfer learning or adaptation techniques of the model of the physical system to adapt the model of the physical system. The method further includes deploying, via the analysis and control system, the adapted model of the physical system to a deployment environment to enable prediction of one or more operational parameters of the physical system.

In another non-limiting embodiment, an analysis and control system includes one or more processors configured to execute processor-executable instructions stored in memory of the analysis and control system. The processor-executable instructions, when executed by the one or more processors, cause the analysis and control system to initially train a model of a physical system, wherein the model of the physical system includes a data-driven model or a hybrid model that includes a combination of a physics-based definition of the physical system and data collected relating to the physical system; to utilize transfer learning or adaptation techniques of the model of the physical system to adapt the model of the physical system; and to deploy the adapted model of the physical system to a deployment environment to enable prediction of one or more operational parameters of the physical system.

In yet another non-limiting embodiment, a non-transitory computer readable medium includes processor-executable instructions, which when executed by one or more processors of an analysis and control system, cause the analysis and control system to initially train a model of a physical system, wherein the model of the physical system includes a data-driven model or a hybrid model that includes a combination of a physics-based definition of the physical system and data collected relating to the physical system; to utilize transfer learning or adaptation techniques of the model of the physical system to adapt the model of the physical system; and to deploy the adapted model of the physical system to a deployment environment to enable prediction of one or more operational parameters of the physical system.

### BRIEF DESCRIPTION OF THE DRAWINGS

Various aspects of this disclosure may be better understood upon reading the following detailed description and upon reference to the drawings, in which:

FIG. 1 illustrates an example oil and gas production system, in accordance with embodiments of the present disclosure;

FIG. 2 depicts a production control system configured to control the oil and gas production system of FIG. 1, in accordance with embodiments of the present disclosure;

FIG. 3 illustrates an example flow chart of a workflow describing how an adaptation technique can adapt a model that is trained/learned in a controlled setting to keep and always align with the system's actual behavior, in accordance with embodiments of the present disclosure;

FIG. 4 illustrates an example of results from offline adaptation of a recurrent neural network (RNN), in accordance with embodiments of the present disclosure; and

FIG. 5 illustrates a flow diagram of a method for adapting models of physical systems using transfer learning or adaptation techniques (e.g., Jacobian Feature Regression) in both online and offline modes.

### DETAILED DESCRIPTION

In the following, reference is made to embodiments of the disclosure. It should be understood, however, that the disclosure is not limited to specific described embodiments. Instead, any combination of the following features and elements, whether related to different embodiments or not, is contemplated to implement and practice the disclosure. Furthermore, although embodiments of the disclosure may achieve advantages over other possible solutions and/or over the prior art, whether or not a particular advantage is achieved by a given embodiment is not limiting of the disclosure. Thus, the following aspects, features, embodiments, and advantages are merely illustrative and are not considered elements or limitations of the claims except where explicitly recited in a claim. Likewise, reference to “the disclosure” shall not be construed as a generalization of inventive subject matter disclosed herein and should not be considered to be an element or limitation of the claims except where explicitly recited in a claim.

When introducing elements of various embodiments of the present disclosure, the articles “a,” “an,” and “the” are intended to mean that there are one or more of the elements. The terms “comprising,” “including,” and “having” are intended to be inclusive and mean that there may be additional elements other than the listed elements. Additionally, it should be understood that references to “one embodiment” or “an embodiment” of the present disclosure are not intended to be interpreted as excluding the existence of additional embodiments that also incorporate the recited features.

When an element or layer is referred to as being “on,” “engaged to,” “connected to,” or “coupled to” another element or layer, it may be directly on, engaged, connected, coupled to the other element or layer, or interleaving elements or layers may be present. In contrast, when an element is referred to as being “directly on,” “directly engaged to,” “directly connected to,” or “directly coupled to” another element or layer, there may be no interleaving elements or layers present. Other words used to describe the relationship between elements should be interpreted in a like fashion. As used herein, the term “and/or” includes any and all combinations of one or more of the associated listed terms.

Some embodiments will now be described with reference to the figures. Like elements in the various figures will be referenced with like numbers for consistency. In the following description, numerous details are set forth to provide an understanding of various embodiments and/or features. It will be understood, however, by those skilled in the art, that some embodiments may be practiced without many of these details, and that numerous variations or modifications from the described embodiments are possible. As used herein, the terms “above” and “below”, “up” and “down”, “upper” and “lower”, “upwardly” and “downwardly”, and other like terms indicating relative positions above or below a given point are used in this description to describe certain embodiments more clearly.

In addition, as used herein, the terms “real time”, “real-time”, or “substantially real time” may be used interchangeably and are intended to describe operations (e.g., computing operations) that are performed without any human-perceivable interruption between operations. For example, as used herein, data relating to the systems described herein may be collected, transmitted, and/or used in control computations in “substantially real time” such that data readings, data transfers, and/or data processing steps occur once every second, once every 0.1 second, once every 0.01 second, or even more frequent, during operations of the systems (e.g., while the systems are operating). In addition, as used herein, the terms “continuous”, “continuously”, or “continually” are intended to describe operations that are performed without any significant interruption. For example, as used herein, control commands may be transmitted to certain equipment every five minutes, every minute, every 30 seconds, every 15 seconds, every 10 seconds, every 5 seconds, or even more often, such that operating parameters of the equipment may be adjusted without any significant interruption to the closed-loop control of the equipment. In addition, as used herein, the terms “automatic”, “automated”, “autonomous”, and so forth, are intended to describe operations that are performed are caused to be performed, for example, by a computing system (i.e., solely by the computing system, without human intervention). Indeed, it will be appreciated that the analysis and control system described herein may be configured to perform any and all of the data processing functions described herein automatically.

In addition, as used herein, the term “substantially similar” may be used to describe values that are different by only a relatively small degree relative to each other. For example, two values that are substantially similar may be values that are within 10% of each other, within 5% of each other, within 3% of each other, within 2% of each other, within 1% of each other, or even within a smaller threshold range, such as within 0.5% of each other or within 0.1% of each other.

Certain existing techniques, for example, the techniques for adapting recurrent neural networks (RNNs) to changes in dynamical systems discussed in Forgione, Marco, Aneri Muni, Dario Piga, and Marco Gallieri. “On the adaptation of recurrent neural networks for system identification.” Automatica 155 (2023): 111092 (e.g., “Forgione”), present certain challenges. The core idea of the Forgione approach is to adapt an existing RNN model, which was trained on a nominal system, to a perturbed system (i.e., the system after changes). Instead of retraining the model from scratch, Forgione proposes adding an adaptive correction term to the model's output. This correction term is designed to account for discrepancies between the nominal system and the perturbed system. This approach, based on Jacobian Feature Regression (JFR) and a non-parametric view using Gaussian processes, offers efficient model adaptation. Forgione particularly utilizes the JFR defined in the feature space defined by the Jacobian of the model with respect to its nominal parameters. Forgione has also proposed a non-parametric view that utilizes the Gaussian process. This could be useful to provide flexibility and efficiency for very large networks or when only a few data points are available. The contributions of this work are significant because they offer a more efficient and effective way to keep RNN models accurate when applied to dynamical systems that experience changes over time.

The embodiments described herein address the shortcomings of Forgione and other similar techniques by providing an improved approach for recalibrating model parameters of retrained machine learning (ML) models through JFR of a lab-developed model to a field environment. In such embodiments, an RNN may be used to model the dynamic system, and this nominal RNN may be trained on available measurements. Then, it is assumed that the system dynamics change, causing the nominal RNN to not be accurate enough for predicting the observed measurements in the presence of these perturbed system dynamics. In other words, an unacceptable degradation of the nominal model performance occurs. A transfer learning approach may be implemented to improve the performance of the nominal model in the presence of perturbed system dynamics, where the nominal model is augmented with additive correction terms that are trained on the currently observed “perturbed-system” data; and these correction terms are learned through a JFR method defined in terms of the features spanned by the model's Jacobian concerning its nominal parameters.

The embodiments described herein extend the implementation of JFR (or other suitable transfer learning or adaptation techniques) to physics-informed neural networks modeled using a state-space formulation and demonstrate that this approach works faster and more accurately than retraining these ML and physics-informed machine learning (PIML) models. The other techniques are based on incoming data, fine-tuning, and using active learning-based approaches to retrain models. In addition, the other techniques also include learning corrective terms, corrective models, and full retraining of the models from scratch. In addition, the embodiments described herein extend the workflows described herein for PHM-based use cases, for example, use cases that are focused on utilizing JFR or other suitable transfer learning or adaptation techniques to improve the robustness of PHM solutions.

The embodiments described herein also demonstrate that JFR is more sustainable than other retraining and transfer learning methods. Prior approaches inherently work in an offline mode, where the adaptation happens once it is triggered based on some prior knowledge or analysis. The embodiments described herein also demonstrate how such offline adaptation approach may be modified into an online adaptation technique. Finally, the embodiments described herein also demonstrate the application of online and offline adaptation algorithms on applications relevant to the oil and gas industry, such as membranes, compressors, and so forth.

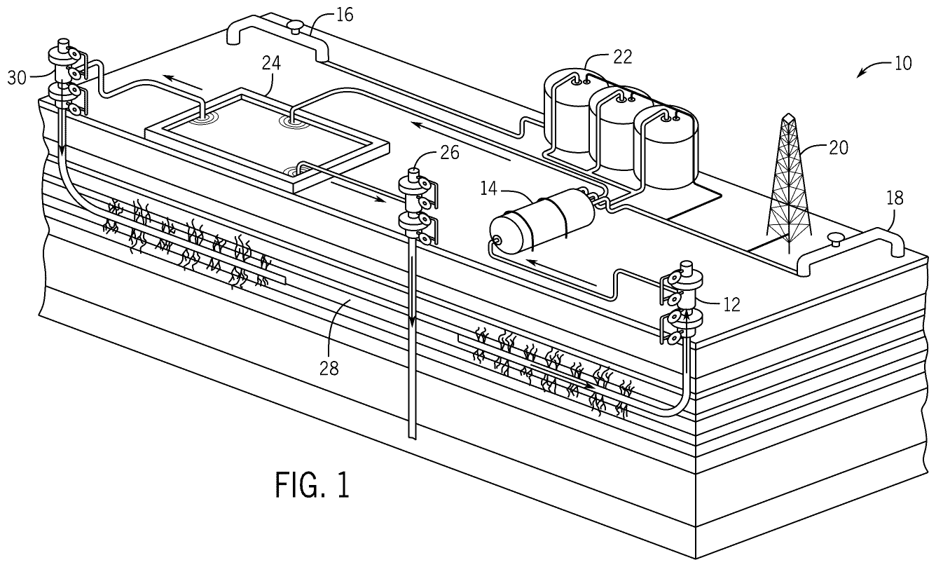

FIG. 1 illustrates an example oil and gas production system 10 having various worksite locations that contain equipment that may be monitored and controlled as described in greater detail herein. As illustrated in FIG. 1, oil and gas is produced along with water at one or more production wells 12. Then, each reservoir fluid (e.g., oil, gas, the produced water, the returned injected hydraulic fracturing fluid, and so forth) may be separated using one or more separators 14 with most of the produced oil and gas being directed into oil and gas pipelines 16, 18, respectively, and the remainder flared via a flare stack 20 and the produced water being directed to a temporary storage facility 22 for local treatment and subsequent storage in, for example, a surface pond 24. In certain embodiments, most of the produced water is re-injected into SWD wells 26 with only a small portion used for fracturing purposes via injection into a formation 28 by one or more fracturing wells 30. As described in greater detail herein, various pieces of equipment at each of the locations illustrated in FIG. 1 may be analyzed using the techniques described herein. Furthermore, the analytic techniques described herein may be extended to other types of production systems other than oil and gas production systems 10.

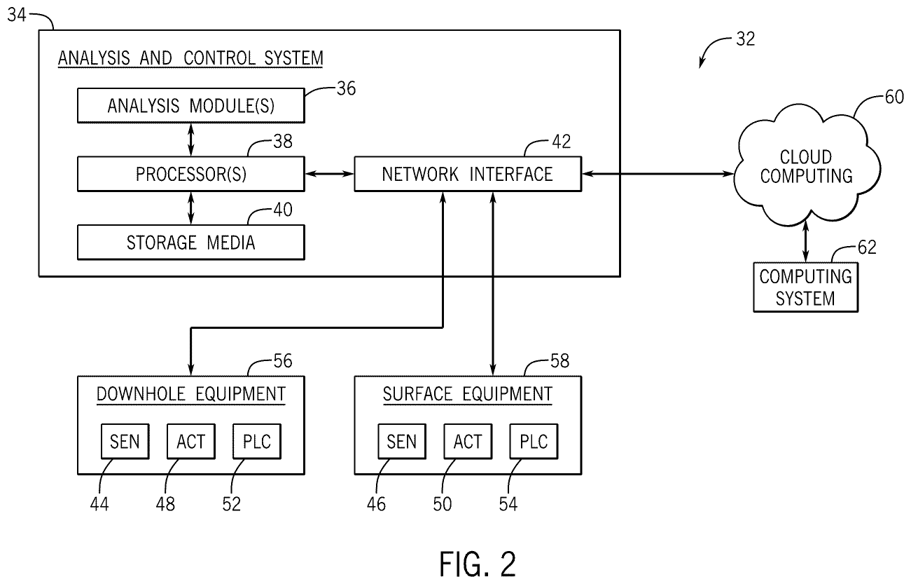

FIG. 2 illustrates a production control system 32 (e.g., that includes the analysis and control system 34) configured to control the oil and gas production system 10 of FIG. 1. In certain embodiments, the analysis and control system 34 may include one or more analysis modules 36 (e.g., a program of computer-executable instructions and associated data) that may be configured to perform various functions of the embodiments described herein. In certain embodiments, to perform these various functions, the one or more analysis modules 36 may execute on one or more processors 38 of the analysis and control system 34, which may be connected to one or more storage media 40 of the analysis and control system 34. Indeed, in certain embodiments, the one or more analysis modules 36 may be stored in the one or more storage media 40.

In certain embodiments, the computer-executable instructions of the one or more analysis modules 36, when executed by the one or more processors 38, may cause the one or more processors 38 to generate one or more models (e.g., forward model, inverse model, mechanical model, and so forth). Such models may be used by the analysis and control system 34 to predict values of operational parameters that may or may not be measured (e.g., using gauges, sensors, and so forth) during operations.

In certain embodiments, the one or more processors 38 may include a microprocessor, a microcontroller, a processor module or subsystem, a programmable integrated circuit, a programmable gate array, a digital signal processor (DSP), or another control or computing device. In certain embodiments, the one or more processors 38 may include machine learning and/or artificial intelligence (AI) based processors. In certain embodiments, the one or more storage media 40 may be implemented as one or more non-transitory computer-readable or machine-readable storage media. In certain embodiments, the one or more storage media 40 may include one or more different forms of memory including semiconductor memory devices such as dynamic or static random access memories (DRAMs or SRAMs), erasable and programmable read-only memories (EPROMs), electrically erasable and programmable read-only memories (EEPROMs) and flash memories; magnetic disks such as fixed, floppy and removable disks; other magnetic media including tape; optical media such as compact disks (CDs) or digital video disks (DVDs); or other types of storage devices. Note that the computer-executable instructions and associated data of the analysis module(s) 36 may be provided on one computer-readable or machine-readable storage medium of the storage media 40, or alternatively, may be provided on multiple computer-readable or machine-readable storage media distributed in a large system having possibly plural nodes. Such computer-readable or machine-readable storage medium or media are considered to be part of an article (or article of manufacture), which may refer to any manufactured single component or multiple components. In certain embodiments, the one or more storage media 40 may be located either in the machine running the machine-readable instructions or may be located at a remote site from which machine-readable instructions may be downloaded over a network for execution.

In certain embodiments, the processor(s) 38 may be connected to a network interface 42 of the analysis and control system 34 to allow the analysis and control system 34 to communicate with multiple downhole sensors 44 and surface sensors 46, as well as communicate with actuators 48, 50 and/or programmable logic controllers (PLCs) 52, 54 of surface equipment 56 and of downhole equipment 58, as described in greater detail herein. In certain embodiments, the network interface 42 may also facilitate the analysis and control system 34 to communicate data to cloud computing resources 60, which may in turn communicate with external computing systems 62 to access and/or to remotely interact with the analysis and control system 34.

It should be appreciated that the production control system 32 illustrated in FIG. 2 is only one example of a production control system, and that the production control system 32 may have more or fewer components than shown, may combine additional components not depicted in the embodiment of FIG. 2, and/or the production control system 32 may have a different configuration or arrangement of the components depicted in FIG. 2. In addition, the various components illustrated in FIG. 2 may be implemented in hardware, software, or a combination of both hardware and software, including one or more signal processing and/or application specific integrated circuits. Furthermore, the operations of the production control system 32 as described herein may be implemented by running one or more functional modules in an information processing apparatus such as application specific chips, such as application-specific integrated circuits (ASICs), field-programmable gate arrays (FPGAs), programmable logic devices (PLDs), systems on a chip (SOCs), or other appropriate devices. These modules, combinations of these modules, and/or their combination with hardware are all included within the scope of the embodiments described herein.

As described above, the embodiments described herein build upon developed JFR algorithms by extending the implementation of JFR (or other suitable transfer learning or adaptation techniques) to physics-informed neural networks modeled using a state-space formulation; demonstrating that JFR is more sustainable than other retraining and transfer learning methods; demonstrating how an offline adaptation approach may be modified into an online adaptation technique; and also demonstrating the application of online and offline adaptation algorithms on applications relevant to the oil and gas industry, such as membranes, compressors, and so forth. Because of the wide-scale demand and applicability of modeling a physical system, the embodiments described herein may be useful for many applications, such as modeling and simulation of dynamic systems and equipment and processes; optimization of systems; control of systems; forecasting of events; prognostics and health management; automation; and decision making, among others.

As described above, modeling and simulation of engineering systems (often referred to as digital twins) benefit many applications, such as optimization, control, forecasting, prognostics and health management, automation, and decision-making, among others. Such models may be physics-based, such as a system of dynamic differential equations, or data-driven, such as a machine learning model (including deep learning models such as artificial neural networks), or a hybrid combination of both physics-based and data-driven models, such as a physics-informed neural network. Typically, building such models involve operating the system in a more constrained environment than the real world, like in a laboratory setting or a machine-shop setting to collect data, and then using this “training dataset” to calibrate the parameters of the model (e.g., equation parameters or weights of the neural networks). Unfortunately, the “test data” and “validation data” for these systems usually come from the real world, where the system will operate when fielded and can sometimes be very different from the laboratory or machine shop setting. In addition, often, a model of a system needs to be built that is different from what was built using stale or obsolete “training data.”

These differences in training and testing datasets are even more apparent in applications of prognostics and health management, where there is a need to have an estimation of the current system state (either nominal or degraded) as well as prediction of when something is going to break/fail in the future so that corrective actions may be taken proactively before the imminent failure state is encountered, rather than reactively after the system has failed.

For applying prognostics and health management (PHM) techniques, having a model representing the system is very important. The model helps establish the nominal expected behavior, which is then compared with the observed system behavior to assess whether an anomaly has been detected in real life. If it is detected, the following stages of PHM workflow are triggered, which helps isolate and quantify the faults. Along with these, the model also helps us determine the Remaining Useful Life (RUL) of the system, which along with the information about the anomaly, faults, and degradation information helps in decision-making. To perform PHM, there is often a requirement to build models of faulty or degraded systems, and it is nearly impossible to replicate all possible failure conditions that the system will encounter when deployed. As such, there are always some gaps in coverage of nominal and faulty operating conditions.

Learning and forming such models is an intensive task requiring a lot of inputs from the subject matter experts (SMEs) and collected data that would be useful for estimating the established behavior of the system. One possible way to create the model is to use the data collected from a controlled environment, such as an environment in a manufacturing facility, and use that data to model the system. However, collecting the data that helps identify faulty scenarios and the changes that might occur in real-life scenarios is nearly impossible. Furthermore, many things vary when the system is deployed, making it relatively difficult to use the data collected from the manufacturing facilities while designing and manufacturing the system. Because of different variations, it becomes difficult to use the learned model representation of the system to carry out all of the various PHM operations, and the model needs to be recalibrated to the current sensor data being received.

A methodology has been developed to recalibrate a lab-developed model to new/different measurements observed in a field/real-world environment. In particular, an RNN may be used to model the dynamic system, and this nominal RNN may be trained on the available measurements. Then, it is assumed that the system dynamics change, causing the nominal RNN to not be accurate enough for predicting the observed measurements in the presence of these perturbed system dynamics. In other words, an unacceptable degradation of the nominal model performance occurs. A transfer learning approach has been proposed to improve the performance of the nominal model in the presence of perturbed system dynamics, where the nominal model is augmented with additive correction terms that are trained on the currently observed “perturbed-system” data; and these correction terms are learned through a JFR method defined in terms of the features spanned by the model's Jacobian concerning its nominal parameters.

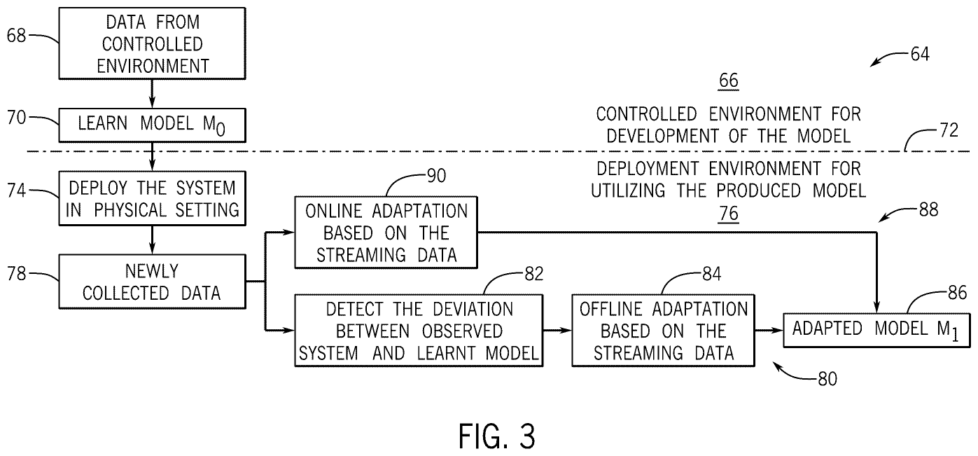

FIG. 3 illustrates an example flow chart of a workflow 64 for utilizing the techniques described herein for developing a robust way that helps take the model built using the data from controlled environments (e.g., manufacturing facilities) and deploy it along with the system, and then use (e.g., continuously, in certain embodiments) the incoming data to adapt the model to ensure the model always in close alignment with the behavior of the system.

As established, the data from the controlled environments 66 (e.g., laboratory) may be used to configure and train different models that represent the system. This is represented by the blocks 68, 70 above the horizontal dotted line 72 in FIG. 3. In particular, data from the controlled environments (e.g., block 68) may be used to initially learn a model Mo (e.g., block 70). However, things tend to change over time once the model Mo is learned and the system is deployed in a physical setting (e.g., the oil and gas production system 10 illustrated in FIG. 1) (e.g., block 74) to be used in the field environment (e.g., the deployment environment 76 below the horizontal dotted line 72 in FIG. 3). Over time, the system's behavior changes, leading to the model M₀ becoming stale and not being in line with the system's behavior. As the system operates in real-life, different measurements may be collected (e.g., collected data 78) and stored in a database. Using the designed approach, there are two choices for model adaptation: Offline Model Adaptation and Online Model Adaptation.

In offline Model Adaptation (e.g., the bottom path 80 illustrated in FIG. 3), the data is continuously collected from the deployment environment 76 in this setting. The model Mo and the system are constantly monitored, and any kind of deviations may be detected and tagged (e.g., block 82). If the deviations are above a given threshold, all of the past information collected before the deviations happen (e.g., the streaming data 84) may be utilized for adapting the model M₁ (e.g., block 86). The bottom path 80 is an offline adaptation technique as not all the incoming information is directly used for adaptation. Rather, the adaptation may be triggered based on the output of anomaly detection. The embodiments described herein extend the offline model adaptation approach of Forgione to hybrid models that represent the dynamics of a system by leveraging both first principles domain knowledge and data-driven ML approaches. One such example of a hybrid modeling approach is physics guided neural networks (PGNN). PGNN uses a first principles model in parallel with data-driven components (e.g., RNNs). It could be helpful to directly use the first principles model, even if it is not tuned and calibrated to the best quality. The developed PGNN architecture may be further coupled with the adaptation technique to help generate a model that is always in close alignment with the physical system.

In online Model Adaptation (e.g., the top path 88 illustrated in FIG. 3), there is no dependency on the anomaly detection process. Rather, as and when new measurements are recorded (e.g., the streaming data 90), they are used for adapting the model M₁ (e.g., block 86). This helps in the continuous utilization of the incoming information. The modification of the adaptation approach to an online form is a new contribution of the embodiments described herein.

Both online and offline adaptation methods (e.g., the top path 88 and the bottom path 80 illustrated in FIG. 3, respectively) have certain drawbacks. Specifically, the online adaptation technique requires a lot of computing power as the models are continuously adapted. Furthermore, observing a single non-standard data point may result in a deviation from the model's behavior, whereas it is not a persistent thing for the physical system. On the other hand, offline adaptation requires dependencies on the anomaly detectors and the storage systems where the data is stored.

A model closely aligned with the physical system helps seamlessly deploy different applications such as optimization, control, forecasting, prognostics and health management, automation, and decision-making, among others, from the first instance the system is deployed. Further, it enables utilization of the incoming data efficiently and update the model constantly. It also enables quantification of the model's behavior change, which could be reflected based on the differences between the models (e.g., Nominal Model: Trained using the data from a controlled setting, Adapted Model: Adapted using incoming data) predictions. In addition, it also enables automatic adjustment of control of operational parameters of the physical system based on the data that changes during operation of the physical system.

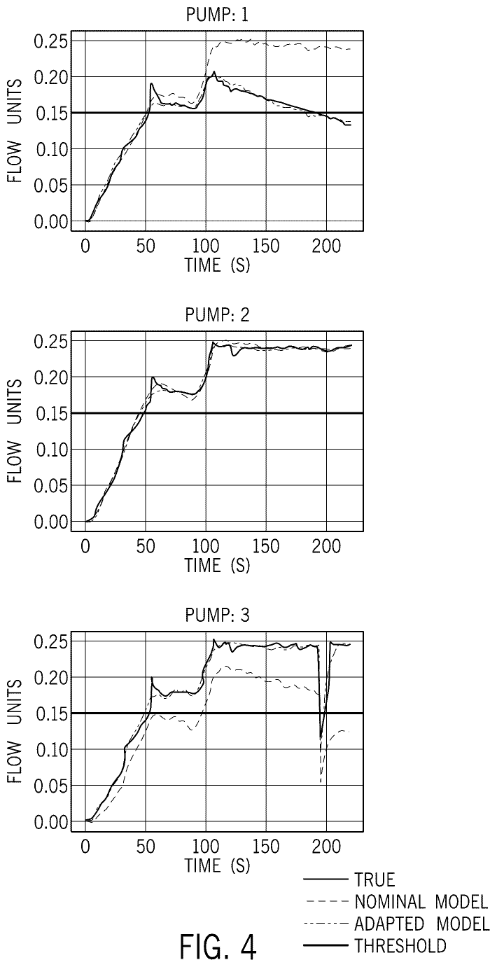

FIG. 4 illustrates an example of results for a dataset that defines a system comprising of three pumps, where the dotted line represents predictions from a nominal model, whereas a first solid line represents the actual system behavior and a second solid line represents the output of the adapted model, which, as observed, is better aligned with the actual expected conduct. The introduced fault for pump #1 is why the observed results differ from the expected. The embodiments described herein also demonstrate that the online and offline model adaptation algorithms using JFR are more sustainable than other retraining and transfer learning methods.

In one embodiment, utilizing the adaptation techniques described herein leads to substantially improved root mean square error (RMSE) and R² results. It is noted that the embodiments described herein do not necessarily take into account certain detected faults, but do take into account deviations from predicted results that are observed in trained models.

Retraining a machine learning model of a dynamic system using sensor readings obtained in a laboratory setting may often not be similar enough to the fielded setting environment. This requires the need to retrain the machine learning model for the fielded scenario. For example, having an updated model support all the different applications including optimization, control, forecasting, prognostics and health management, automation, and decision-making, among others, is important.

The embodiments described herein address these unmet needs by providing a fast and more robust way of dealing with transfer learning. Further, the embodiments described herein support the vision of having more robust models representing the system that allow reliable solutions that help mitigate the risks of running the system into a bad state and be more proactive in the actions to fix the system early on. The major bottleneck that arises with the current methods to model the system is the delay in collecting the data and the time spent creating/learning the model after that. The embodiments described herein allow for reduction of the delay by efficiently using data from the controlled settings such as the manufacturing facilities and using the real-time collected data for both online and offline adaptation of the model to reflect the system's current state.

The embodiments described herein may be applied to many various applications. In essence, any application that requires the dynamic modeling of systems will benefit from the embodiments described herein. Such applications include, but are not limited to, optimization, control, forecasting, prognostics and health management, automation, and decision-making.

The embodiments described herein allow for relatively fast deployment of data-driven models from lab-to-field scenarios. In addition, the embodiments described herein also extend approaches to the adaptation of hybrid PIML approaches to new data. In addition, the embodiments described herein demonstrate that this methodology works on multiple datasets pertinent to the oil and gas industry. In addition, the embodiments described herein further showcase that this methodology utilizes less power, thereby contributing fewer carbon emissions. The relatively fast and robust adaptation of the models enable the models to be “evergreen” and “constantly updated” and adapt to wear and tear and other degradation of the system. As a result, the embodiments described herein make the PHM process more reliable by ensuring that the system model is continuously adapted to reflect the system state's most up-to-date and true representation.

The embodiments described herein also make it easier for the models created on different datasets to be adapted to their current fielded environments. This adaptation will enable the models to be “evergreen” and “constantly updated” and be able to adapt to wear and tear and other degradation of the system, useful for RUL prediction. The embodiments described herein may also help be more sustainable with a reduced carbon footprint compared to complete retraining. The embodiments described herein may also be used for both online and offline adaptation given the adaptation is faster than complete retraining.

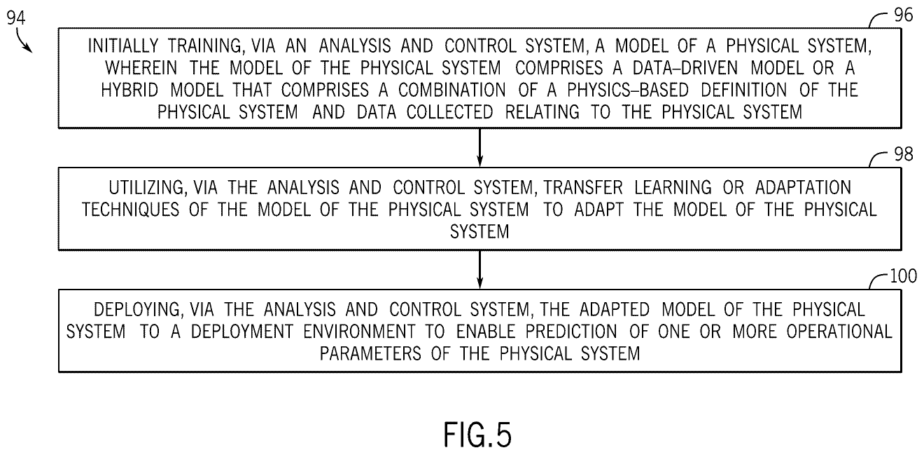

FIG. 5 illustrates a flow diagram of a method 94 (e.g., to be at least partially performed by the analysis and control system 34) for adapting models of physical systems using transfer learning or adaptation techniques (e.g., Jacobian Feature Regression) in both online and offline modes. For example, the method 98 may include initially training, via the analysis and control system 34, a model of a physical system (e.g., equipment 56, 58 illustrated in FIG. 2). The model of the physical system includes a data-driven model or a hybrid model that includes a combination of a physics-based definition of the physical system and data collected relating to the physical system (block 96). The method 94 may also include utilizing, via the analysis and control system 34, transfer learning or adaptation techniques of the model of the physical system to adapt the model of the physical system (block 98). The method 94 may also include deploying, via the analysis and control system 34, the adapted model of the physical system to a deployment environment to enable prediction of one or more operational parameters of the physical system (block 100).

In addition, in certain embodiments, the method 94 may include utilizing, via the analysis and control system 34, JFR of the model of the physical system to adapt the model of the physical system. In addition, in certain embodiments, the method 94 may include automatically controlling, via the analysis and control system 34, the one or more operational parameters of the physical system based at least in part on the adapted model of the physical system. In addition, in certain embodiments, the method 94 may include utilizing, via the analysis and control system 34, the transfer learning or adaptation techniques on a state-space formulation of the hybrid model of the physical system to adapt the model of the physical system. In addition, in certain embodiments, the model of the physical system comprises a recurrent neural network (RNN). In addition, in certain embodiments, the method 94 may include utilizing, via the analysis and control system34, the transfer learning or adaptation techniques on a state-space formulation of the model of the physical system based at least in part on data detected from the physical system that changes during operations of the physical system to adapt the model of the physical system. In addition, in certain embodiments, the method 94 may include utilizing, via the analysis and control system 34, the transfer learning or adaptation techniques on the state-space formulation of the model of the physical system based at least in part on data detected in a controlled environment separate from the physical system to adapt the model of the physical system.

While embodiments have been described herein, those skilled in the art, having benefit of this disclosure, will appreciate that other embodiments are envisioned that do not depart from the inventive scope. Accordingly, the scope of the present claims or any subsequent claims shall not be unduly limited by the description of the embodiments described herein.

The techniques presented and claimed herein are referenced and applied to material objects and concrete examples of a practical nature that demonstrably improve the present technical field and, as such, are not abstract, intangible, or purely theoretical. Further, if any claims appended to the end of this specification contain one or more elements designated as “means for [perform]ing [a function] . . . ” or “step for [perform]ing [a function] . . . ”, it is intended that such elements are to be interpreted under 35 U.S.C. § 112(f). However, for any claims containing elements designated in any other manner, it is intended that such elements are not to be interpreted under 35 U.S.C. § 112(f).

What is claimed is:

1. A method, comprising:
initially training, via an analysis and control system, a model of a physical system, wherein the model of the physical system comprises a data-driven model or a hybrid model that comprises a combination of a physics-based definition of the physical system and data collected relating to the physical system;
utilizing, via the analysis and control system, transfer learning or adaptation techniques of the model of the physical system to adapt the model of the physical system; and
deploying, via the analysis and control system, the adapted model of the physical system to a deployment environment to enable prediction of one or more operational parameters of the physical system.

2. The method of claim 1, comprising utilizing, via the analysis and control system, Jacobian Feature Regression (JFR) of the model of the physical system to adapt the model of the physical system.

3. The method of claim 1, comprising automatically controlling, via the analysis and control system, the one or more operational parameters of the physical system based at least in part on the adapted model of the physical system.

4. The method of claim 1, comprising utilizing, via the analysis and control system, the transfer learning or adaptation techniques on a state-space formulation of the hybrid model of the physical system to adapt the model of the physical system.

5. The method of claim 1, wherein the model of the physical system comprises a recurrent neural network (RNN).

6. The method of claim 1, comprising utilizing, via the analysis and control system, the transfer learning or adaptation techniques on a state-space formulation of the model of the physical system based at least in part on data detected from the physical system that changes during operations of the physical system to adapt the model of the physical system.

7. The method of claim 6, comprising utilizing, via the analysis and control system, the transfer learning or adaptation techniques on the state-space formulation of the model of the physical system based at least in part on data detected in a controlled environment separate from the physical system to adapt the model of the physical system.

8. An analysis and control system, comprising:
one or more processors configured to execute processor-executable instructions stored in memory of the analysis and control system, wherein the processor-executable instructions, when executed by the one or more processors, cause the analysis and control system to:
initially train a model of a physical system, wherein the model of the physical system comprises a data-driven model or a hybrid model that comprises a combination of a physics-based definition of the physical system and data collected relating to the physical system;
utilize transfer learning or adaptation techniques of the model of the physical system to adapt the model of the physical system; and
deploy the adapted model of the physical system to a deployment environment to enable prediction of one or more operational parameters of the physical system.

9. The analysis and control system of claim 8, wherein the processor-executable instructions, when executed by the one or more processors, cause the analysis and control system to utilize Jacobian Feature Regression (JFR) of the model of the physical system to adapt the model of the physical system.

10. The analysis and control system of claim 8, wherein the processor-executable instructions, when executed by the one or more processors, cause the analysis and control system to automatically control the one or more operational parameters of the physical system based at least in part on the adapted model of the physical system.

11. The analysis and control system of claim 8, wherein the processor-executable instructions, when executed by the one or more processors, cause the analysis and control system to utilize the transfer learning or adaptation techniques on a state-space formulation of the model of the physical system to adapt the model of the physical system.

12. The analysis and control system of claim 8, wherein the model of the physical system comprises a recurrent neural network (RNN).

13. The analysis and control system of claim 8, wherein the processor-executable instructions, when executed by the one or more processors, cause the analysis and control system to utilize the transfer learning or adaptation techniques on a state-space formulation of the model of the physical system based at least in part on data detected from the physical system that changes during operations of the physical system to adapt the model of the physical system.

14. The analysis and control system of claim 13, wherein the processor-executable instructions, when executed by the one or more processors, cause the analysis and control system to utilize the transfer learning or adaptation techniques on the state-space formulation of the model of the physical system based at least in part on data detected in a controlled environment separate from the physical system to adapt the model of the physical system.

15. A non-transitory computer readable medium, comprising:
processor-executable instructions, which when executed by one or more processors of an analysis and control system, cause the analysis and control system to:
initially train a model of a physical system, wherein the model of the physical system comprises a data-driven model or a hybrid model that comprises a combination of a physics-based definition of the physical system and data collected relating to the physical system;
utilize transfer learning or adaptation techniques of the model of the physical system to adapt the model of the physical system; and
deploy the adapted model of the physical system to a deployment environment to enable prediction of one or more operational parameters of the physical system.

16. The non-transitory computer readable medium of claim 15, wherein the processor-executable instructions, when executed by the one or more processors of the analysis and control system, cause the analysis and control system to utilize Jacobian Feature Regression (JFR) of the model of the physical system to adapt the model of the physical system.

17. The non-transitory computer readable medium of claim 15, wherein the processor-executable instructions, when executed by the one or more processors of the analysis and control system, cause the analysis and control system to automatically control the one or more operational parameters of the physical system based at least in part on the adapted model of the physical system.

18. The non-transitory computer readable medium of claim 15, wherein the processor-executable instructions, when executed by the one or more processors of the analysis and control system, cause the analysis and control system to utilize the transfer learning or adaptation techniques on a state-space formulation of the model of the physical system to adapt the model of the physical system.

19. The non-transitory computer readable medium of claim 15, wherein the processor-executable instructions, when executed by the one or more processors of the analysis and control system, cause the analysis and control system to utilize the transfer learning or adaptation techniques on a state-space formulation of the model of the physical system based at least in part on data detected from the physical system that changes during operations of the physical system to adapt the model of the physical system.

20. The non-transitory computer readable medium of claim 19, wherein the processor-executable instructions, when executed by the one or more processors of the analysis and control system, cause the analysis and control system to utilize the transfer learning or adaptation techniques on the state-space formulation of the model of the physical system based at least in part on data detected in a controlled environment separate from the physical system to adapt the model of the physical system.
